(19) United States
(12) Patent Application Publication
(10) Pub. No.: US 2010/0176260 A1
(43) Pub. Date: Jul. 15, 2010

(54) Suction foot operating mechanism with pivot lever

(76) Inventor: Harald Richter, Engelbrand (DE)

Correspondence Address: KLAUS J. BACH, 4407 TWIN OAKS DRIVE, MURRYSVILLE, PA, 15668, US

(21) Appl. No.: 12/584,538

(22) Filed: Sep. 8, 2009

(30) Foreign Application Priority Data
Jan. 14, 2009 (DE) 20 2009 000 548.8

(51) Int. Cl. F16B 47/00

(52) U.S. Cl. 248/205.8

(57) ABSTRACT

In a suction foot operating mechanism comprising a suction foot housing with a suction membrane, a shaft attached to the suction membrane, a transverse pin extending through a transverse opening in the shaft remote from the suction membrane and a pivot lever of plastic including two legs each having a transverse opening receiving one of the ends of the transverse pin and a cam structure supported on the top side of the suction foot housing, the transverse openings of the legs of the pivot lever are in the form of dead end openings which are closed on the outside by a wall and each dead end opening is provided with a radially extending insert passage with a cross-section reduction so that the legs of the pivot lever can be snapped onto the ends of the transverse pin.

### BACKGROUND OF THE INVENTION

Suction foot structures are widely used for example for apparatus carriers for supporting mobile telephones, mobile navigation apparatus, minicomputers and similar apparatus, in motor vehicles where the apparatus carriers can be mounted by means of the suction devices for example on the inner surface of the windshield of a vehicle so that the apparatus are easily visible to the vehicle operator.

The operating mechanism of such a suction foot comprises generally a shaft mounted to the center of a flexible suction membrane and an operating members which abuts the top side of the suction foot and, upon actuation, pulls the shaft up so as to pull and curve the suction membrane into the suction foot housing or, for releasing the suction foot, to move the shaft downwardly in order to move the suction membrane into a flattened position.

As operating member generally a pivot lever is used, which is connected to the shaft by way of a transverse pin. To this end, the shaft is provided at its upper end with a transverse bore and the pivot lever has, in a top view, an about U-shaped configuration with two legs which extend at opposite sides of the shaft and have transverse bores accommodating the ends of the transverse pin.

Adjacent the suction foot housing, there is usually a sleeve structure disposed on top of the suction foot housing which, dependent on the embodiment of the apparatus holder, serves only for accommodating and guiding the shaft or, which, in connection with so-called goose neck holders, serves also as connection structure for mounting the goose neck. The transverse pin consequently does not extend only through the shaft but also through axial longitudinal slots which are formed in the sleeve structure at diametrically opposite areas thereof and which permit the passing of the transverse pin and its movement over a certain distance along the sleeve.

With this arrangement, the assembly of the suction foot operating mechanism is relatively complicated and time consuming. The shaft, at the lower end of which the suction membrane is mounted, must be introduced into the suction foot housing and into the sleeve; then the transverse pin needs to be inserted through the respective openings of the two legs of the pivot lever, the elongated openings of the sleeve and the transverse opening of the shaft. All these parts need to be held in their proper positions. It is also to be considered that the transverse pin still needs to be fixed to prevent axial displacement thereof. This is achieved in that the transverse pin is pressed into the transverse bore of the shaft, wherein the transverse pin is provided for this purpose generally with a surface profile permitting an elastic deformation. However, in particular the need for pressing the transverse pin into the opening makes the procedure difficult complicated and expensive.

It is therefore the object of the invention to simplify this assembly procedure.

### SUMMARY OF THE INVENTION

In accordance with the invention, the pivot lever is provided at the outside of its legs with closed walls which prevent transverse movement of the transverse pin. The transverse openings which are formed in the legs for accommodating the transverse pin are then in the form of deadened bores which have radially extending insert openings with flanks which, because of the material elasticity of the plastic material of which the pivot lever consists, act as notches and form with the transverse pin a spring catch, via which the transverse pin can be installed in the transverse openings.

Because of this pivot lever design, the transverse pin no longer needs to be pressed into the transverse bore of the shaft but simple insertion is enough since the transverse pin does not need to be retained anymore by a force fit or firm engagement fit in the transverse bore of the shaft to prevent sideward displacement, as this function is now taken over by the outside walls of the pivot lever legs.

For the assembly of the suction foot, it is furthermore no longer necessary to properly position and concurrently hold the shaft, the suction foot housing with the sleeve disposed thereon and the pivot lever for inserting the transverse pin but only the two components shaft and suction housing. This greatly facilitates and speeds up the insertion of the transverse pin since the pressing or pounding in with a hammer is no longer necessary. This also eliminates the chances of damaging the suction housing. After insertion of the transverse pin, the pivot lever is simply snapped into position. In this way, the transverse pin is fixed so as to prevent sideward movement thereof and the assembly is completed.

Below a particular embodiment of the invention will be described in detail with reference to the enclosed drawings.

### BRIEF DESCRIPTION OF THE DRAWINGS

FIG. 1 shows schematically a cross-section through a suction foot mechanism;

FIG. 2 is a perspective view of the suction device operating lever as seen at an angle from above, and

FIG. 3 is a perspective view of the suction lever as seen at an angle from below.

### DESCRIPTION OF PARTICULAR EMBODIMENTS

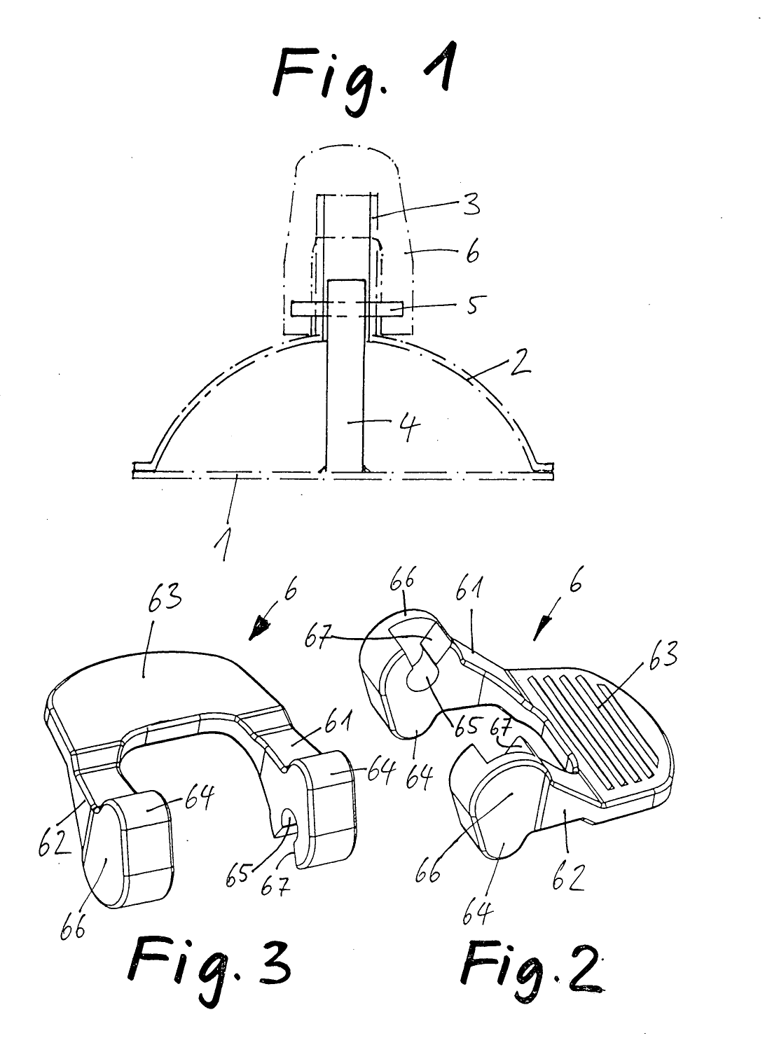

FIG. 1 shows schematically a suction foot operating mechanism. Herein, the suction membrane 1 and the suction foot housing 2 with a guide sleeve 3 formed thereon are shown only schematically (by dash-dotted lines). The operating mechanism itself comprises the shaft 4, which is mounted to the center of the membrane 1, the transverse pin 5, which extends through a transverse bore in the upper part of the shaft 4 and the pivot lever 6, which abuts, with the cams 64 formed on the two legs 61, 62, the suction foot housing 2. In FIG. 1, the pivot lever 6 is indicated only by dash-dotted outer contour lines in order not to hide the other components.

FIGS. 2 and 3 show, in two perspective views, that is at an angle from the top and at an angle from below, the pivot lever 6, whereby the various features of the lever design are apparent.

In accordance with FIGS. 2 and 3, the pivot lever has an actuating plate 63 from which the two legs 61, 62 extend.

The two legs 61, 62 are each formed with a cam structure 64 via which each leg is supported on the top side of the suction foot housing 2.

The legs 61, 62 each include at the inner opposite side faces thereof a transversely extending cavity 65 for accommodating the opposite ends of the transverse pin 5. Further, each leg 61, 62 has an outer wall 66 closing the dead end opening so that the transverse pin 5 cannot slide sidewardly.

Finally, each leg is provided with a radial insert opening 67 whose side walls are in the form of inclined flanks forming a narrowing passage whose narrowest area gap is slightly smaller than the diameter of the transverse pin 5.

While the shaft 4 and the transverse pin 5 generally consist of metal, the pivot lever consists of plastic. Because of the material elasticity of the plastic material, the pivot lever 6 can be snapped with its two legs 61, 62 onto the opposite ends of the transverse pin 5 if the shaft 4 and the transverse pin 5 are pre-mounted in the suction foot housing 2.

In the shown embodiment, the radial insert openings 67 leading to the dead end bores 65 of the two legs 61, 62 are V-shaped in such a way that the pivot lever 6 can be snapped onto the ends of the transverse pin 5 in a direction about normal to the general plane of the pivot lever. However, the insert openings may also be so arranged that they extend about in the longitudinal direction of the legs 61, 62 and face away from the operating plate 63. They are provided with an installation ramp in such a way that, when the legs are snapped onto the transverse pin, the legs are elastically spread outwardly and then snap again together over the ends of the transverse pin.

What is claimed is:

1. A suction foot operating mechanism comprising a suction foot housing (2) with a suction membrane (1), a shaft (4) attached to the suction membrane (1) and having a transverse bore, a transverse pin (5) extending through the transverse bore in the end of the shaft (4) remote from the suction membrane (1) and a pivot lever (6) consisting of plastic with an operating plate (63) and two legs (61, 62) which extend therefrom each having a transverse openings (65) accommodating an end of the transverse pin (5) and a cam structure (64) formed thereon and supported on the top side of the suction foot housing (2) into which the suction membrane (1) can be curved upon actuation of the pivot lever (6), the transverse openings (65) of the legs (61, 62) of the pivot lever (6) being in the form of dead end openings which are closed at the outside by a wall (66) and each dead end opening being provided with a radial insert passage (67) having at least one inlet flank and a cross-section reduction so configured that the legs of the pivot lever (6) can be snapped onto the ends of the transverse pin (5).

2. Operating mechanism according to claim 1, wherein the insert passage (67) extends about normal to the main plane of the pivot lever (6) and have two V-shaped outwardly diverging side walls.

3. Operating mechanism according to claim 1, wherein the insert passages (67) extend about in the longitudinal direction away from the operating plate (63) and each includes a ramp which cooperates with the respective end of the transverse pin (5) and which temporarily causes spreading of the legs apart during snapping the legs onto the transverse pin.
